(19) United States
(12) Patent Application Publication
(10) Pub. No.: US 2026/0080571 A1
(43) Pub. Date: Mar. 19, 2026

(54) METHOD AND APPARATUS FOR ENCODING/DECODING POINT CLOUDS AND RECORDING MEDIUM STORING BITSTREAM THEREOF

(71) Applicant: Electronics and Telecommunications Research Institute, Daejeon (KR)

(72) Inventors: Soo Woong KIM, Daejeon (KR); Jun Sik KIM, Daejeon (KR); Ji Hoon DO, Daejeon (KR); Seong Jun BAE, Daejeon (KR); Gun BANG, Daejeon (KR); Ha Hyun LEE, Daejeon (KR); Jung Won KANG, Daejeon (KR); Jin Soo CHOI, Daejeon (KR)

(73) Assignee: Electronics and Telecommunications Research Institute, Daejeon (KR)

(21) Appl. No.: 19/324,898

(22) Filed: Sep. 10, 2025

(30) Foreign Application Priority Data
Sep. 13, 2024 (KR) 10-2024-0126040
May 14, 2025 (KR) 10-2025-0062836

(51) Int. Cl. G06T 9/00

(52) U.S. Cl. CPC G06T 9/001

(57) ABSTRACT

A method for decoding a point cloud according to a present disclosure, the method comprises: generating predicted point cloud data of a current frame based on point cloud data of a previous frame; decoding residual data of the current frame; and reconstructing the point cloud data of the current frame based on the predicted point cloud data and the residual data, wherein the predicted point cloud data of the current frame is generated based on spread point cloud data of the previous frame.

### CROSS-REFERENCE TO RELATED APPLICATIONS

This application claims the benefit of earlier filing date and right of priority to Korean Application No. 10-2024-0126040, filed on Sep. 13, 2024 and Korean Application No. 10-2025-0062836, filed on May 14, 2025, the contents of which are all hereby incorporated by reference herein in their entirety.

### TECHNICAL FIELD

The present disclosure relates to an inter-frame point cloud encoding/decoding method and apparatus and a recording medium storing a bitstream. More specifically, the present disclosure relates to a method and apparatus for inter-frame point cloud encoding/decoding using a point spread technique without motion information, and a recording medium storing a bitstream.

### BACKGROUND

Most point cloud compression and reconstruction techniques are based on compressing inter-frame data using motion prediction and compensation. Since this approach involves accurately predicting motion information and compressing it, complex motion compensation techniques are essential. This increases computational complexity and reduces data compression and reconstruction efficiency. In particular, for data containing a lot of motion information or complex movements, the quality of reconstructed data may be degraded due to errors occurring during the motion compensation process, so additional computational resources and time may be required to correct errors. This complexity makes it unsuitable for applications that require real-time processing of large-scale 3D data, such as point clouds. Accordingly, various techniques have been developed to reduce the complexity of motion information processing and improve the efficiency of compression and reconstruction.

### SUMMARY

The technical object of the present disclosure is to provide a method for encoding/decoding a point cloud using a point spread technique.

It is a further object of the present disclosure to provide a method for encoding/decoding a point cloud using a point refinement technique.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a method and apparatus for decoding a point cloud, the method and apparatus comprising: generating predicted point cloud data of a current frame based on point cloud data of a previous frame; decoding residual data of the current frame; and reconstructing the point cloud data of the current frame based on the predicted point cloud data and the residual data, wherein the predicted point cloud data of the current frame is generated based on spread point cloud data of the previous frame.

In the method and apparatus for decoding the point cloud according to the present disclosure, based on whether coordinates are the same as coordinates of the spread point cloud data of the previous frame, the predicted point cloud data of the current frame is classified into an overlapping point or a non-overlapping point.

In the method and apparatus for decoding the point cloud according to the present disclosure, based on the predicted point cloud data being the overlapping point, a predicted attribute has the same value as a spread attribute of the previous frame, and based on the predicted point cloud data being the non-overlapping point, a predicted attribute has a value of 0.

In the method and apparatus for decoding the point cloud according to the present disclosure, based on the predicted point cloud data being the non-overlapping point, point refinement is further performed, and the point refinement compensates an attribute of the non-overlapping point with an attribute of the overlapping point.

In the method and apparatus for encoding a point cloud according to the present disclosure, generating predicted point cloud data of a current frame based on point cloud data of a previous frame; and deriving residual data of the current frame based on a difference between the predicted point cloud data and point cloud data of the current frame and encoding the residual data, wherein the predicted point cloud data of the current frame is generated based on spread point cloud data of the previous frame.

In accordance with an aspect of the present disclosure, the above and other objects can be accomplished by the provision of a recording medium for storing a bitstream generated by a point cloud encoding method according to the present disclosure.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

FIG. 1 is a flowchart illustrating a point cloud encoding method using a point spread technique according to one embodiment of the present disclosure.

FIG. 2 illustrates an example in which inter-frame prediction is performed using a point spread technique according to one embodiment of the present disclosure.

FIG. 3 illustrates an example of spread point cloud data according to one embodiment of the present disclosure.

FIG. 4 illustrates an example of overlapping points and non-overlapping points according to one embodiment of the present disclosure.

FIG. 5 is a flowchart illustrating a point cloud decoding method using a point spread technique according to one embodiment of the present disclosure.

FIG. 6 is a block diagram illustrating an apparatus for performing a point cloud encoding method using a point spread technique according to one embodiment of the present disclosure.

FIG. 7 is a block diagram illustrating an apparatus for performing a point cloud decoding method using a point spread technique according to one embodiment of the present disclosure.

### DETAILED DESCRIPTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. As an example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. As an example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

First, the terms used in this application are briefly explained as follows.

A point cloud may refer to a set of points in three-dimensional space. Point cloud data may include coordinates and/or attributes for at least one point comprising the point cloud. The Coordinates may be understood as being replaced by geometry. The attributes may be understood as being replaced by features or characteristics.

Coordinate(s) may represent position information in three-dimensional space.

Attribute(s) may represent information that quantifies the characteristics of a point. They can include at least one of color, normal vector, or latent representation information.

The point cloud may be encoded/decoded based on inter-frame prediction. The inter-frame prediction may be performed based on motion prediction and compensation. However, inter-frame motion prediction and compensation for point cloud have the following issues.

First, since multiple coordinates are irregularly distributed, it is challenging to find point correspondences between two frames, which is necessary for inter-frame prediction. Second, point cloud has dynamic characteristics and exhibits complex motion. Complex motions, such as object rotation, nonlinear movement, speed changes, and occlusion, occur frequently, making accurate motion prediction difficult. Third, there is the point-to-point correspondence problem. It may be difficult to find point alignment because the density and resolution of points comprising the point cloud vary from frame to frame, or because some points disappear and new points appear. Fourth, there are issues with sensor noise and uncertainty. Point cloud is sensitive to noise of a sensor such as LiDAR and to distance measurement errors, and motion prediction may be difficult due to the sensor noise. Fifth, since point cloud deals with 3D spatial data, they have higher computational complexity than 2D image, and motion prediction in high dimensions may be very difficult.

Due to the above-described problems, inter-frame prediction of point cloud based on motion prediction and compensation may be difficult and computationally expensive, and complex algorithms may be required to address the above problems.

Accordingly, the present disclosure provides a method for encoding/decoding point cloud based on inter-frame prediction using a point spread technique. According to the method proposed in the present disclosure, inter-frame prediction of point cloud may be performed without motion information.

Prior to describing the method, a point cloud will be defined.

The point cloud of the previous frame may be defined as

$${x}^{t} = \{ {c}_{x}^{t} , {f}_{x}^{t} \} .$$

### Here,

$${c}_{x}^{t}$$

may refer to the 3D coordinates of the point cloud of the previous frame. Here

$$, {f}_{x}^{t}$$

may refer to the attributes of the point cloud of the previous frame.

The point cloud of the current frame may be defined as

$${x}^{t + 1} = \{ {c}_{x}^{t + 1} , {f}_{x}^{t + 1} \} .$$

### Here,

$${c}_{x}^{t + 1}$$

may refer to the 3D coordinates of the point cloud of the current frame. Here

$${f}_{x}^{t + 1}$$

may refer to the attributes of the point cloud of the current frame.

The encoded point cloud of the previous frame may be defined as

$${y}^{t} = \{ {c}_{y}^{t} , {f}_{y}^{t} \} .$$

### Here

$${c}_{y}^{t}$$

may refer to the 3D coordinates of the encoded point cloud of the previous frame. Here,

$${f}_{y}^{t}$$

may refer to the attributes of the encoded point cloud of the previous frame.

The encoded point cloud of the current frame may be defined as

$${y}^{t + 1} = \{ {c}_{y}^{t + 1} , {f}_{y}^{t + 1} \} .$$

### Here,

$${c}_{y}^{t + 1}$$

may refer to the 3D coordinates of the encoded point cloud of the current frame. Here,

$${f}_{y}^{t + 1}$$

may refer to the attributes of the encoded point cloud of the current frame.

The spread point cloud of the previous frame may be defined as

$${\overline{y}}^{t} = \{ {c}_{\overline{y}}^{t} , {f}_{\overline{y}}^{t} \} .$$

### Here,

$${c}_{\overline{y}}^{t}$$

may refer to the 3D coordinates of the spread point cloud of the previous frame. Here,

$${f}_{\overline{y}}^{t}$$

may refer to the attributes of the point cloud of the previous frame.

Hereinafter, the method proposed in the present disclosure will be described in detail.

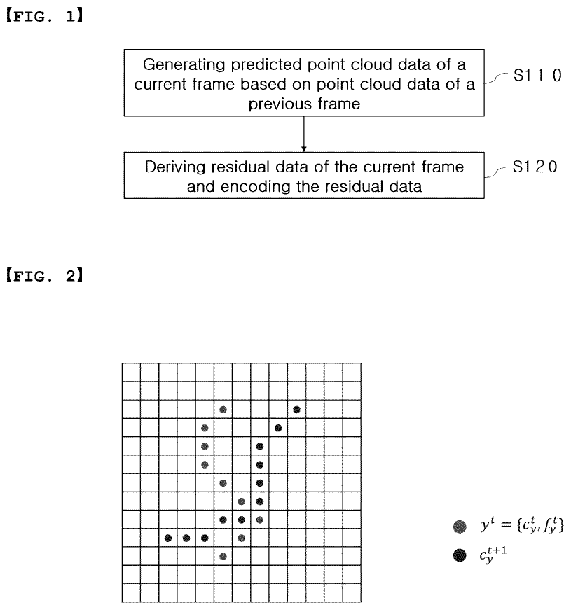

FIG. 1 is a flowchart illustrating a point cloud encoding method using a point spread technique according to one embodiment of the present disclosure.

Referring to FIG. 1, predicted point cloud data of a current frame is generated based on point cloud data of a previous frame S110.

According to one embodiment of the present disclosure, predicted point cloud data of the current frame may be generated based on spread point cloud data of the previous frame.

FIG. 2 illustrates an example in which inter-frame prediction is performed using a point spread technique according to one embodiment of the present disclosure.

Referring to FIG. 2, the attributes corresponding to the coordinates of the current frame may be predicted from the point cloud data of the previous frame. That is, the attributes corresponding to the encoded coordinates

$${c}_{y}^{{}_{t + 1}}$$

of the current frame may be predicted from the encoded point cloud data

$${y}^{{}_{t}} = \{ {c}_{y}^{{}_{t}} , {f}_{y}^{t} \}$$

of the previous frame.

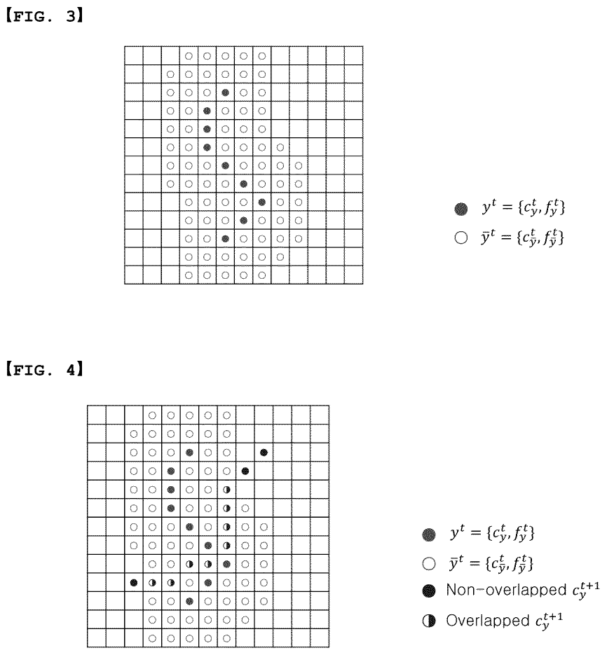

Meanwhile, FIG. 3 illustrates an example of spread point cloud data according to one embodiment of the present disclosure.

By spreading the encoded point cloud of the previous frame in three-dimensional space, a spread point cloud y̅^{t} of the previous frame may be generated.

The point spread technique according to the present disclosure may mean the technique for spreading the influence of a point into the surrounding space. For example, the spread may be performed based on a convolution operation. Specifically, the output may be derived by performing an operation through sliding a predetermined kernel over at least one point. The kernel may include a Gaussian kernel.

The method proposed in the present disclosure may classify the predicted point cloud of the current frame into overlapping points and non-overlapping points. The classification may be performed based on whether the coordinates of the predicted point cloud of the previous frame and the coordinates of the predicted point cloud of the current frame overlap or not.

FIG. 4 illustrates an example of overlapping points and non-overlapping points according to one embodiment of the present disclosure.

Referring to FIG. 4, if the coordinates of the predicted point cloud data of the current frame and the coordinates of the spread point cloud data of the previous frame are the same, the predicted point cloud of the current frame may be distinguished as an overlapping point.

Referring to FIG. 4, if the coordinates of the predicted point cloud data of the current frame and the coordinates of the spread point cloud data of the previous frame are not the same, the predicted point cloud of the current frame may be distinguished as a non-overlapping point.

Based on the overlap of points, the attributes corresponding to the coordinates of the current frame may be predicted.

According to one embodiment of the present disclosure, the attributes corresponding to the coordinates of the current frame may be predicted from spread point cloud data of the previous frame. Specifically, the attributes

$${\tilde{f}}_{y}^{{}_{t + 1}}$$

corresponding to the coordinates

$${c}_{y}^{t + 1}$$

of the encoded current frame may be predicted from spread point cloud data

$${\overline{y}}^{{}_{t}} = \{ {c}_{\overline{y}}^{t} , {f}_{\overline{y}}^{t} \}$$

of the previous frame.

In one example, if the predicted point cloud data is an overlapping point, the predicted attributes may have the same value as the spread attributes of the previous frame.

In one example, if the predicted point cloud data is a non-overlapping point, the predicted attributes may have a value of 0.

The predicted attributes may be expressed as in the following mathematical equation 1.

$${\tilde{f}}_{y}^{{}_{t + 1}} ( p ) \{ \begin{matrix}{f}_{\overline{y}}^{t} ( p ) if p ∈ {c}_{\overline{y}}^{t} \\ 0 otherwise\end{matrix} \qquad [ Mathematical equation l ]$$

That is, for all points p belonging to

$${c}_{y}^{t + 1} ,$$

the overlapping points may copy the spread attributes of the previous frame, and the non-overlapping points may be filled with the value 0.

According to one embodiment of the present disclosure, if the predicted point cloud data are non-overlapping points, point refinement may be additionally performed.

Point refinement may mean compensating or correcting the attributes of non-overlapping points with the attributes of overlapping points. Point refinement can improve prediction accuracy by correcting the attributes of non-overlapping points.

Referring to FIG. 1, residual data of the current frame can be derived and encoded S120.

In the encoding apparatus, residual data, which is the difference between the predicted point cloud of the current frame and the point cloud of the current frame, may be derived and encoded. In the decoding apparatus, the residual data of the current frame may be decoded.

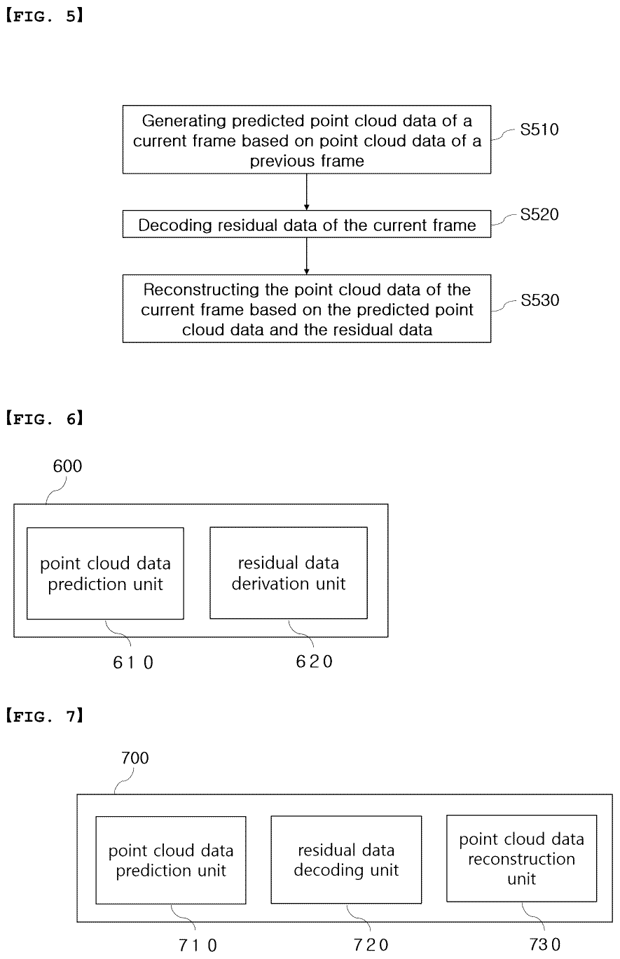

FIG. 5 is a flowchart illustrating a point cloud decoding method using a point spread technique according to one embodiment of the present disclosure.

Referring to FIG. 5, predicted point cloud data of a current frame is generated based on point cloud data of a previous frame S510.

It can be understood that the method according to the present disclosure is performed in the same manner in the decoding apparatus, and thus a detailed description thereof is omitted here to avoid redundant explanation.

Referring to FIG. 5, residual data of the current frame is decoded S520.

It can be understood that the method according to the present disclosure is performed in the same manner in the decoding apparatus, and thus a detailed description thereof is omitted here to avoid redundant explanation.

Referring to FIG. 5, the point cloud data of the current frame is reconstructed based on the predicted point cloud data and the residual data S530.

The reconstruction may be performed by adding residual data to the predicted point cloud data of the current frame.

Meanwhile, FIG. 6 is a block diagram illustrating an apparatus 600 for performing a point cloud encoding method using a point spread technique according to one embodiment of the present disclosure.

Referring to FIG. 6, the point cloud data prediction unit 610 may perform the operation of S110. As described in detail with reference to FIG. 1, a detailed description thereof will be omitted here.

Referring to FIG. 6, the residual data derivation unit 620 may perform the operation of S120. As described in detail with reference to FIG. 1, a detailed description thereof will be omitted here.

FIG. 7 is a block diagram illustrating an apparatus 700 for performing a point cloud decoding method using a point spread technique according to one embodiment of the present disclosure.

Referring to FIG. 7, the point cloud data prediction unit 710 may perform the operation of S510. As described in detail with reference to FIG. 5, a detailed description thereof will be omitted here.

Referring to FIG. 7, the residual data decoding unit 720 can perform the operation of S520. As described in detail with reference to FIG. 5, a detailed description thereof will be omitted here.

Referring to FIG. 7, the point cloud data reconstruction unit 730 may perform the operation of S530. As described in detail with reference to FIG. 5, a detailed description thereof will be omitted here.

The point cloud encoding/decoding method proposed in the present disclosure, using the point spread technique, reduces bit rate by performing prediction without motion information and simplifies the structure of the encoding/decoding apparatus. The method is advantageous for real-time processing of point cloud data, increases data transmission speed, and reduces storage space.

The method proposed in the present disclosure may be utilized in autonomous driving. The method may be effectively used to encode and decode point cloud data collected from LiDAR in autonomous driving systems. Since the method processes data without motion prediction, it enables rapid data processing and transmission in the real-time environment of autonomous vehicles, and it can efficiently compress and store data.

The method proposed in the present disclosure may be utilized in virtual reality and 3D scanning. The method may be utilized to efficiently compress and reconstruct point cloud data in applications such as virtual reality (VR) and 3D scanning. By processing inter-frame data without motion prediction, it may enable high-performance data transmission and real-time rendering in VR/AR environments. Furthermore, it may maximize the storage and transmission efficiency of 3D scan data.

Furthermore, the method proposed in this disclosure may be utilized in various computer vision applications. For example, in applications requiring real-time processing of data with complex 3D structures, the method can accurately process data without motion compensation. This can be applied in various fields, including medical imaging, smart cities, and drone data analysis.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof. At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method for decoding a point cloud, comprising:
generating predicted point cloud data of a current frame based on point cloud data of a previous frame;
decoding residual data of the current frame; and
reconstructing the point cloud data of the current frame based on the predicted point cloud data and the residual data,
wherein the predicted point cloud data of the current frame is generated based on spread point cloud data of the previous frame.

2. The method of claim 1, wherein based on whether coordinates are the same as coordinates of the spread point cloud data of the previous frame, the predicted point cloud data of the current frame is classified into an overlapping point or a non-overlapping point.

3. The method of claim 2, wherein based on the predicted point cloud data being the overlapping point, a predicted attribute has the same value as a spread attribute of the previous frame, and
wherein based on the predicted point cloud data being the non-overlapping point, a predicted attribute has a value of 0.

4. The method of claim 2, wherein based on the predicted point cloud data being the non-overlapping point, point refinement is further performed, and
wherein the point refinement compensates an attribute of the non-overlapping point with an attribute of the overlapping point.

5. A method for encoding a point cloud, comprising:
generating predicted point cloud data of a current frame based on point cloud data of a previous frame; and
deriving residual data of the current frame based on a difference between the predicted point cloud data and point cloud data of the current frame and encoding the residual data,
wherein the predicted point cloud data of the current frame is generated based on spread point cloud data of the previous frame.

6. A recording medium for storing a bitstream generated by a point cloud encoding method comprising:
generating predicted point cloud data of a current frame based on point cloud data of a previous frame; and
deriving residual data of the current frame based on a difference between the predicted point cloud data and point cloud data of the current frame and encoding the residual data,
wherein the predicted point cloud data of the current frame is generated based on spread point cloud data of the previous frame.
